(19) United States
(12) Patent Application Publication
(10) Pub. No.: US 2020/0156277 A1
(43) Pub. Date: May 21, 2020

(54) Separating device for the chipless cutting to length of plastic workpieces, in particular plastic pipes

(71) Applicant: ROTHENBERGER AG, Kelkheim (DE)

(72) Inventor: Thoralf Krause, Leipzig (DE)

(73) Assignee: ROTHENBERGER AG, Kelkheim (DE)

(21) Appl. No.: 16/619,159

(22) PCT Filed: May 24, 2018
(86) PCT No.: PCT/DE2018/100506

§ 371 Date: Dec. 4, 2019

(30) Foreign Application Priority Data
Jun. 6, 2017 (DE) 10 2017 112 431.4

(51) Int. Cl. B26D 3/16; B26D 7/08

(52) U.S. Cl. CPC B26D 3/169; B26D 7/088

(57) ABSTRACT

A separating device for the chipless cutting to length of plastic workpieces, in particular plastic pipes, has a support part as support for the plastic workpiece and a blade which is movable relative to the support part. The separating device is configured to supply a wetting liquid to the blade at its contact point with the plastic workpiece to be machined. A method for the chipless cutting to length of a plastic workpiece uses a water-containing gel as an application lubricant for the contact points on the workpiece side during the chipless cutting to length of a plastic or plastic composite workpiece.

### TECHNICAL FIELD

The disclosure relates to a separating device for the chipless cutting to length of plastic workpieces, in particular plastic pipes.

### BACKGROUND

Such separating devices are used, for example, for constructing heating and/or sanitary areas of buildings, and serve the purpose, among other things, of cutting to a predetermined length plastic pipes that are installed or to be installed. The separating devices usually have a cutting part with a blade that can be moved from a starting position to a cutting position, where the blade rests against the plastic pipe to be cut. Typically, the separating devices have a support part against which the plastic pipe to be cut is placed prior to the cutting process and which serves as a support for the pipe during the cutting process.

The cutting process takes place by pressing the blade against the plastic pipe in such a manner that the blade penetrates into the material of the plastic pipe, and a cut is made which continues until the plastic pipe is cut through by means of the blade. Frequently, the blade must be pressed against the plastic pipe with a force that is so great that a considerable permanent deformation of the plastic pipe occurs. This makes it more difficult to attach an additional pipe or an attachment part, such as a fitting.

### SUMMARY

It is therefore a task of the invention to provide a separating device of the type mentioned at the beginning, through which a plastic workpiece, such as a plastic pipe, can be cut with a low degree of deformation.

This task is solved with a separating device as claimed.

A basic separating device for the chipless cutting to length of plastic workpieces, such as plastic pipes, comprises a support part as a support for the plastic workpiece and a blade that can be moved relative to the support part. Plastic workpieces are understood in particular as those workpieces which consist of or comprise plastic. For example, this also includes workpieces made of or with composite material, in particular multilayer composite material, such as so-called “multilayer workpieces.”

In particular, the separating device is suitable for beginning to cut and cutting into one of the plastic workpieces described above, making the further cut through the plastic workpiece and finally carrying out the cutting off. Individual steps of such steps can also be carried out using the separating device. In particular, the support part serves as a support for the plastic workpiece, in order to, for example, place the plastic workpiece on it prior to or during the cutting process. The support part can be designed as a holder for the plastic workpiece, for example to form a holding jaw. The support part can also have a blade and thus perform the function of an additional blade.

According to one embodiment, the separating device is configured to supply a wetting liquid to the blade at at least one contact point or contact area thereof with the plastic workpiece to be machined. The separating device thus enables the blade to be wetted, to be precise in the area of contact with the plastic workpiece to be machined. This contact point or contact area is, for example, a cutting zone created during the cutting process of the plastic workpiece. It has been shown that wetting the contact point with the wetting liquid counteracts possible undesirable deformation of the plastic workpiece during the cutting process, in particular plastic deformations. Possibly, such deformations are completely or largely avoided.

Experiments have shown that the cutting force required for cutting is significantly reduced if the blade is wetted by the wetting liquid. For example, in the case of a multilayer pipe with an outer diameter of 25 millimeters, a reduction of approximately one-quarter of the required cutting force was observed. The wetting thus exploits the effect of a reduced cutting force to cut through the plastic workpiece. Due to the reduced cutting force, any deformations, in particular plastic deformations, are reduced or do not occur at all. If the plastic workpiece is a plastic pipe and a fitting or a pipeline is to be connected to the separated end of the plastic pipe, this may eliminate or at least facilitate the calibration of the plastic pipe that was cut through, which was previously required.

According to one arrangement, it is provided with the separating device that the surface of the blade has a hydrophilic coating or etching. In addition or alternatively, the surface of the blade can be provided with a structure using capillary action. For example, the structure using capillary action is formed by pores, grooves, scoring and/or a defined statistical roughness of the surface of the blade. Such measures help to improve the ability to wet the surface of the blade and thus promote the wetting of the blade by the wetting liquid.

According to an additional arrangement, it is provided with the separating device that the wetting liquid is oil-free and grease-free or essentially oil-free and grease-free. This allows the separating device to be used in food-sensitive and/or environmentally sensitive areas. For example, the separating device can be used to cut plastic pipes for drinking water lines, the water of which is used, for example, in buildings for drinking, cooking, preparing food and beverages, personal hygiene and cleaning and/or for cleaning objects.

In particular, it is provided that the wetting liquid is water-containing or water-based. Thus, the water of a water line, for example a drinking water line, can form the wetting liquid or be used to produce the wetting liquid, wherein, for example, the plastic workpiece or plastic pipe to be cut through is a component of the water line or is provided for the water line.

In addition, the wetting liquid may have a proportion, in particular a small proportion, of a wetting agent. This supports the reduction of the interfacial tension between the surface of the blade and the wetting liquid, in order to facilitate the flow of the wetting liquid from the surface of the blade to the plastic workpiece to be machined. The wetting agent may be a surfactant or alcohol or may contain a surfactant or alcohol.

The wetting liquid can be applied to the blade in different ways and/or the wetting liquid can be held at the blade. For example, according to one possible embodiment of the separating device, it is provided that the wetting liquid is bound in a gel that is applied to the blade.

In addition or alternatively, it can be provided that the wetting liquid is fed to the blade through an adjacent structure using capillary action. The structure using capillary action can be a sponge or a wick. For example, the structure is arranged in the area of the support part and/or in the area of a base body holding the blade in a movable manner. Thus, the structure is positioned where the blade brushes past during the cutting process, in particular where at least part of the wetting liquid is carried along by the blade at least at its contact point with the plastic workpiece to be machined.

In addition or alternatively, it may also be provided that the wetting liquid is brought to the blade by a conveying device. The conveying device may be an electrically and/or hydraulically and/or pneumatically operated pump. The conveying device can also be operated manually. For example, the conveying device has a flexible receiving container and/or storage container that can be manually pressed in for the wetting liquid, which, by compressing or pressing in, sets at least a partial quantity of the received wetting liquid into a conveying movement. For example, the flexible container is a so-called “pump bag.”

Alternatively, the conveying device can be movement-coupled with a drive mechanism for the blade, which serves to drive the blade, in particular to set the blade in motion to cut the workpiece to be machined. The drive mechanism is thus additionally used as a drive for the conveying device. The drive mechanism may comprise a lever and/or ratchet mechanism and/or a ratchet drive, or may be formed from it.

According to a possible arrangement, the separating device has a collecting device for collecting a quantity of wetting liquid flowing off the blade. This allows the consumption of wetting liquid to be kept low when the separating device is used. This also makes it possible to keep the machining area clean. The collecting device may have an absorbent structure, in particular a sponge, or be formed from it.

According to an additional arrangement of the separating device, a storage container for the wetting liquid is provided. The storage container enables the separating device to be used independently at least for a certain period of time or for several operations, without replenishing a quantity of the wetting liquid. The storage container may be within a cavity of one of the components of the separating device. This makes it possible to store the wetting liquid in an optically inconspicuous manner.

One possible embodiment of the separating device is that the separating device is designed for the chipless cutting to length of plastic workpieces by means of knife action, and the blade is a knife blade. For example, the blade has a cutting tip, which is formed by two inclined planes converging towards each other at an acute angle. The cutting tip may be formed by two inclined planes converging towards each other at an angle of less than 5 degrees. It may also be provided that the blade has a cutting edge or cutting tip that runs in a straight line or essentially runs in a straight line. The blade can also be arranged so that it can move in a swiveling manner relative to the support part.

For example, the blade has a cutting edge that runs in a straight line over at least one length section. For example, the cutting edge has two length sections, in particular length sections adjacent to each other, which are at an angle to each other. It has been shown that after one of the length sections has entered the material to be cut, the following cutting process is facilitated if at least two length sections of the cutting edge, which are at an angle to each other, are provided. In principle, the cutting edge can also have at least one length section over which the cutting edge is curved.

According to an additional possible embodiment, the separating device can be manually operated to cut to length the plastic workpiece. For example, the separating device has two handle parts that can be moved relative to each other. This makes it possible to cut through the plastic workpiece in a simple and flexible manner in terms of handling technology. The separating device is also relatively cost-effective to implement. A simple operation is supported if the handle parts are designed as hand levers, which are mounted in a manner pivotable against each other.

An additional arrangement of the separating device provides that one of the handle parts is in operative connection with the blade, such that, by moving the one handle part, the blade is moved relative to the support part from a receiving position to a cutting position with respect to the plastic workpiece. For this purpose, a drive mechanism or the drive mechanism described above may be provided; through this, the one handle part is in operative connection with the blade. For example, the drive mechanism has a ratchet drive that moves the blade and that is actuated by the one handle part.

For example, the handle part in operative connection with the blade can be mounted in a manner pivoted on one or more of the base bodies described above. The support part can be fixed to the base body in such a manner that it cannot move; in particular, it can be molded onto it. The other part of the handle can also be fixed to the base body in such a manner that it cannot move; in particular, it can be molded onto it. The blade, in turn, can be mounted on the base body and/or on the other handle part in a movable manner, in particular in a pivoting manner.

With an additional arrangement of the separating device, it is provided that the drive mechanism is or has a lever operation, and that the blade and the support part are scissor legs of the lever operation that can be swiveled against each other. The handle parts are also scissor legs of the lever operation that can be swiveled against each other. By swiveling the handle parts against each other, the swiveling of the cutting part relative to the support part is effected in this way, and in this manner, the cutting through of the plastic workpiece is completed.

According to an additional aspect of the invention, a method for the chipless cutting to length of a plastic workpiece, in particular a plastic pipe, is provided by means of a blade penetrating the plastic workpiece along the provided cutting surface. For this purpose, the method can use the separating device described above and cut to length, in a chipless manner, the plastic workpiece using the blade of the separating device. According to one embodiment, it is provided with the method that a wetting liquid is applied to the surface of the blade that comes into contact with the plastic workpiece.

It has been shown that the wetting liquid acts as a lubricant with the plastic workpiece to be machined and that the cutting force to be applied for cutting through is reduced when the surface of the blade is wetted with the wetting liquid. It has also been shown that, in this manner, possible undesirable deformations of the plastic workpiece during the cutting process, in particular plastic deformations, are counteracted.

With the method, a water-containing gel can be used as an application lubricant for the contact points of the blade on the workpiece side upon the chipless cutting to length of the plastic workpiece.

An additional aspect of the invention relates to the use of a water-containing gel as an application lubricant for the contact points on the workpiece side of a blade, for example the separating device described above upon the chipless cutting to length of a plastic or a plastic composite workpiece. The workpiece can be the plastic workpiece described above.

Further details and characteristics of the invention arise from the following description of several exemplary embodiments on the basis of the drawing.

### BRIEF DESCRIPTION OF THE DRAWINGS

FIG. 1 shows a possible embodiment of a separating device for the chipless cutting to length of plastic workpieces in a perspective illustration.

FIG. 2 shows an additional possible embodiment of a separating device for the chipless cutting to length of plastic workpieces in a perspective illustration.

FIG. 3 shows an additional possible embodiment of a separating device for the chipless cutting to length of plastic workpieces in a perspective illustration.

### DETAILED DESCRIPTION

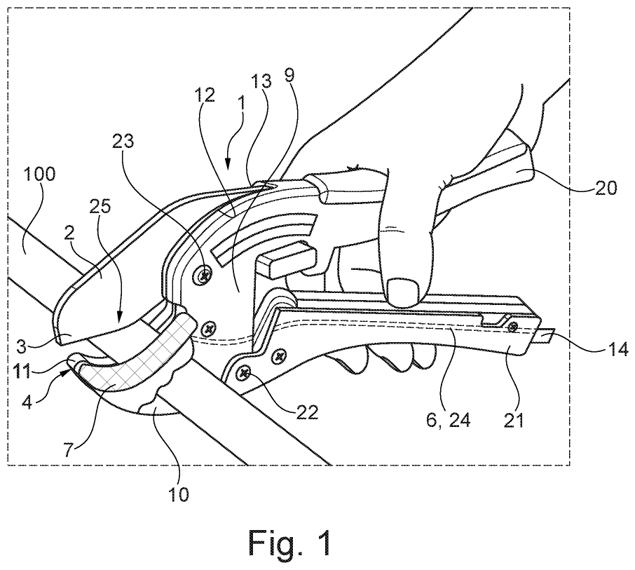

FIG. 1 shows—in schematic representation—a separating device 1 for the chipless cutting to length of plastic workpieces, such as plastic pipes, or other deformable workpieces. The separating device 1 is used, for example, for constructing heating and/or sanitary areas of buildings and serves, among other things, to cut pipes that are installed or to be installed to a predetermined length. The separating device 1 can be used to cut through pipes made of plastic or pipes that comprise plastic. Likewise, pipes made of multilayer composite material, so-called multilayer pipes, can be cut through by means of the separating device 1. FIG. 1 shows an example of a workpiece 100 to be cut through, which is a plastic pipe therein.

The separating device 1, for example, has a support part 4 as support for the workpiece 100 to be machined and a blade 3 that is movable relative to the support part 4 for cutting to length the workpiece 100. The blade 3 is preferably a part of a cutting part 2 or forms a cutting part 2. The separating device 1 is in particular configured to supply a wetting liquid to the blade 3 at at least one contact point or contact area 25 thereof with the workpiece 100 to be machined. The wetting liquid reduces the cutting force required to cut through the workpiece to 100, thus reducing possible deformation caused by the effective cutting force. Thus, plastic deformations of the workpiece due to the effective cutting force can be largely or completely avoided. In this respect, the wetting liquid has a lubricant function.

In order to promote the ability to wet the blade 3, the surface of blade 3 and/or cutting part 2 preferably has a hydrophilic coating or etching. In addition or alternatively, the surface of the blade 3 and/or the cutting part 2 can be provided with a structure using capillary action. For example, the structure using capillary action is formed by pores, grooves, scoring and/or a defined statistical roughness of the surface of the blade 3 and/or the cutting part 2.

The wetting liquid is preferably oil-free and grease-free or essentially oil-free and grease-free. For example, the wetting liquid is water-containing or water-based, and has in particular a small proportion of a wetting agent, such as a surfactant or an alcohol. If the separating device 1 is used to construct a water line, such as a drinking water line, the water from the water line can then be used to produce the wetting liquid or can be used directly as the wetting liquid for the separating device 1.

Preferably, the separating device 1 is manually operable in order to cut to length the workpiece 100. For example, the separating device 1 is designed as a manually operable pipe cutter. For manual operation, the separating device 1 can have two handle parts 20, 21, which can be moved against each other. Furthermore, the separating device 1 may have a base body 9 on which one of the handle parts 21, 22, in particular the handle part 21, is mounted in a manner pivotable around a pivot axis 22. Preferably, the other handle part 20 is fastened to the base body 9 in a fixed connection; in particular, it is molded onto it. The handle parts 20, 21 are preferably designed as hand levers, which can be swiveled against each other around the pivot axis 22.

The blade 3 or the cutting part 2 is preferably mounted on the base body 9 so that it can pivot around an axis of rotation 23. Preferably, the pivot axis 23 is arranged parallel or essentially parallel to the pivot axis 22. Preferably, the support part 4 is fixed to the base body 9 in such a manner that it cannot move; in particular, it is molded onto it. This structure of the separating device 1, when the handle parts 20 and 21 are actuated, in particular when the handle part 21 is pivoted in the direction of the handle part 20, exerts an actuating movement on the blade 3 or the cutting part 2 via a drive mechanism, by means of which the blade 3 or the cutting part 2 is pivoted in the direction of the support part 4. The drive mechanism may have a ratchet drive. In such a case, for example, the handle parts 20 and 21 must be pressed on relative to each other several times in order to move the blade 2 or the cutting part 2 in several stages in the direction of the support part 4 and, for example, to bring them into a cutting position on the workpiece 100.

In order to feed the wetting liquid to the blade 3 or the cutting part 2, a structure using capillary action 7 can be provided, with which the blade 3 or the cutting part 2 comes into contact, for example in the course of the cutting movement. The structure using capillary action 7 can be arranged in the area of the support part 4. The blade 3 or the cutting part 2 can brush past the structure using capillary action 7 during a movement to cut through the workpiece 100, and in this manner the blade 3 at its contact point or its contact area 25 with the workpiece 100 can be wetted with the wetting liquid.

Preferably, the structure using capillary action 7 has a material that can absorb and/or release the wetting liquid. For example, the structure using capillary action 7 has a sponge-like material or consists of a sponge-like material or sponge. Alternatively, the structure using capillary action 7 can also be a wick. According to another design, the wetting liquid can be bound in a gel, which is applied to the blade 3 or cutting part 2 in the area of the contact point or contact area 25, for example.

In FIG. 1, for example, the support part 4 is formed by two support jaws 10 and 11, which are arranged at a distance from each other, such that, upon a movement to cut through the workpiece 100, the blade 3 or the cutting part 2 dips between the support jaws 10 and 11. For example, the structure using capillary action 7 of the support jaw 10 is allocated there.

In an additional arrangement, two structures using capillary action can also be provided, such that, upon a movement to cut through the workpiece 100, the blade 3 or the cutting part 2 dips between the support jaws 10 and 11 while brushing past the two structures using capillary action. In this manner, the two cutting sides of cutting part 2 and the blade 3 are each wetted by one of the structures using capillary action.

The structure using capillary action 7 can be connected to a feed 6, such that a quantity of the wetting liquid can be fed to the structure using capillary action 7 via the feed 6. The feed 6 can have a supply line 24 that extends, for example, along one of the handle parts 20, 21, and is connected to a port 14 at the front end of one handle part 20 or 21. Through the port 14, it is possible to connect, for example, an external filling device, in order to fill the structure using capillary action 7 with the wetting liquid.

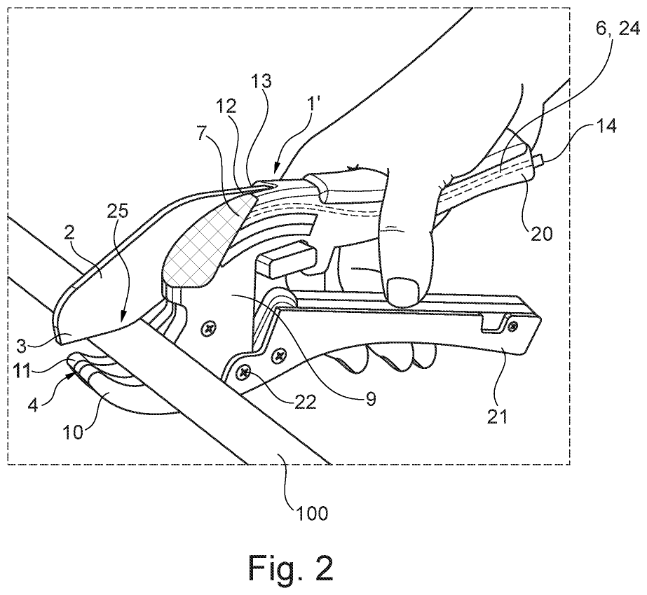

FIG. 2 shows an additional possible embodiment of a separating device 1′ for the chipless cutting to length of plastic workpieces, such as plastic pipes. Components of the separating device 1′ according to FIG. 2 that are identical or functionally identical to components of the separating device 1 according to FIG. 1 are marked with the same reference signs; in this respect, reference is made to the description of the separating device 1 according to FIG. 1.

The separating device 1′ differs from the separating device 1 according to FIG. 1 in that, among other things, the structure using capillary action 7 is arranged on the base body 9 in the area of the cutting part 2. For example, the base body 9 has two walls 12, 13 spaced apart from each other, between which the cutting part 2 is accommodated in a movable manner. Upon a movement for cutting through the workpiece 100, the cutting part 2 skims the structure using capillary action 7 and in this manner wets the cutting part 2 or the blade 3 at its contact point or contact area 25 with the workpiece 100. In FIG. 2, the separating device 1′ on the wall 12 has the structure using capillary action 7.

In principle, two structures using capillary action can also be provided, wherein one structure using capillary action is then arranged on the wall 12 and the other structure using capillary action is arranged on the wall 13. Upon a movement for cutting through the workpiece 100, the structures using capillary action then skim against the cutting part 2 or the blade 3 on both sides, such that wetting by the wetting liquid takes place on both sides of the cutting part 2 or the blade 3.

As an example, the port 14 and the supply line (not made visible in FIG. 2) are located in the handle part 20 of the disconnecting device 1′, which is arranged on the base body 9 in such a manner that it cannot move.

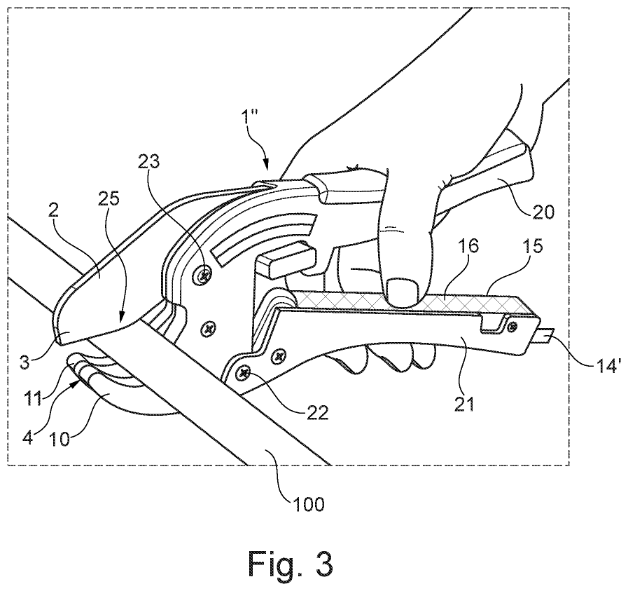

FIG. 3 shows an additional embodiment of a separating device 1″. Components of the separating device 1″ that are identical or functionally identical to components of the separating device 1 according to FIG. 1 are marked with the same reference signs; in this respect, reference is made to the description of the separating device 1 according to FIG. 1.

The separating device 1″ differs from the separating device 1 of FIG. 1 and the separating device 1′ of FIG. 2 in that, among other things, a storage container 15 is provided for storing the wetting liquid. Preferably, the storage container 15 is integrated into a cavity 16 of the separating device 1″. For example, the cavity 16 is a cavity of one of the handle parts 20, 21. A port 14′ is provided on the handle 20 or 21 for filling the storage container 15, to which port a filling line can be coupled in order to fill or refill the storage container 15 with a quantity of the wetting liquid.

In this description, a reference to a particular aspect or embodiment or arrangement means that a particular feature or characteristic described in connection with that aspect or embodiment or arrangement is at least contained therein, but need not necessarily be contained in all aspects or embodiments or arrangements of the invention. It is expressly stated that any combination of the various characteristics and/or structures and/or properties described in relation to the invention are covered by the invention, unless this is expressly or unambiguously disproved by the context.

The use of individual or all examples or an exemplary manner of expression in the text is provided only to illuminate the invention and does not constitute a limitation on the scope of the invention, unless otherwise stated. Nor is any expression or wording of the description to be understood as meaning that it is an element that is not claimed but that is essential to the practice of the invention.

### LIST OF REFERENCE SIGNS

1 Device
1′ Device
1″ Device
2 Cutting part
3 Blade
4 Support part
6 Feed
7 Structure using capillary action
9 Base body
10 Supportjaw
11 Supportjaw
12 Wall
13 Wall
14 Port
14′ Port
15 Storage container
16 Cavity
20 Handle part
21 Handle part
22 Pivot axis
23 Pivot axis
24 Supply line
25 Contact area
100 Workpiece

1.-22. (canceled)

23. A separating device for the chipless cutting of plastic workpieces, comprising:
a support part as support for the plastic workpiece; and
a blade that can be moved relative to the support part,
wherein the separating device is configured to supply a wetting liquid to the blade at a contact point with the plastic workpiece to be machined.

24. The separating device according to claim 23,
wherein a surface of the blade has a hydrophilic coating or etching and/or is provided with a structuring using capillary action.

25. The separating device according to claim 23,
wherein the wetting liquid is oil-free and grease-free.

26. The separating device according to claim 23,
wherein the wetting liquid is water-containing or water-based and includes a wetting agent.

27. The separating device according to claim 23,
wherein the wetting liquid is bound in a gel that is applied to the blade.

28. The separating device according to claim 23,
wherein the wetting liquid is supplied to the blade by an adjacent sponge or wick using capillary action.

29. The separating device according to claim 28,
wherein the sponge or wick is arranged
in an area of the support part or
in an area of a base body holding the blade in a movable manner.

30. The separating device according to claim 23,
wherein the wetting liquid is brought to the blade by a conveying device.

31. The separating device according to claim 30,
wherein the conveying device has a flexible container for receiving the wetting liquid, which, by compressing or pressing in, sets at least a partial quantity of the received wetting liquid into a conveying movement.

32. The separating device according to claim 30,
wherein the conveying device is movement-coupled with a drive mechanism for the blade, and
wherein the drive mechanism is additionally used as a drive for the conveying device.

33. The separating device according to claim 23,
wherein the separating device further comprises a collecting device for collecting a quantity of the wetting liquid flowing off the blade.

34. The separating device according to claim 33,
wherein the collecting device has an absorbent structure.

35. The separating device according to claim 23,
wherein the separating device has a storage container for the wetting liquid.

36. The separating device according to claim 35,
wherein the storage container is arranged in a cavity of one component of the separating device.

37. The separating device according to claim 23,
wherein the separating device is configured for the chipless cutting of the plastic workpieces by knife action and
wherein the blade is a knife blade.

38. The separating device according to claim 23,
wherein the blade has a cutting tip that is formed by two inclined planes converging towards each other at an acute angle of less than 5 degrees.

39. The separating device according to claim 23,
wherein the blade has at least one cutting edge that runs in a straight line at least over a length section.

40. The separating device according to claim 23,
wherein the blade is arranged so that it can move in a swiveling manner relative to the support part.

41. The separating device according to claim 23,
wherein the separating device comprises two handle parts that are movable relative to each other to manually operate the separating device when cutting the plastic workpiece to length.

42. A method for the chipless cutting of a plastic pipe, comprising:
providing the separating device as in claim 23;
applying the wetting liquid to a surface of the blade; and
pushing the blade through the plastic pipe.

43. The method according to claim 42,
wherein the wetting liquid is a water-containing gel.
